(19) United States
(12) Patent Application Publication
(10) Pub. No.: US 2017/0009931 A1
(43) Pub. Date: Jan. 12, 2017

(54) WASHERS FOR MOUNTING ENGINE MOUNTING MEMBERS AND ACCOMMODATING THERMAL GROWTH

(71) Applicant: CUMMINS POWER GENERATION IP, INC., MINNEAPOLIS, MN (US)

(72) Inventors: CHARLES D. KNEALING, ANDOVER, MN (US); GARY SANDLASS, MAPLE PLAIN, MN (US); PAUL D. JOHNSON, MINNEAPOLIS, MN (US); GUNJAN MAHESHWARI, BLAINE, MN (US); EUGENE M. BURMA, MILACA, MN (US); WILLIAM B. HORNSETH, PLYMOUTH, MN (US)

(73) Assignee: CUMMINS POWER GENERATION IP, INC., MINNEAPOLIS, MN (US)

(21) Appl. No.: 15/204,820

(22) Filed: Jul. 7, 2016

Related U.S. Application Data
(60) Provisional application No. 62/190,605, filed on Jul. 9, 2015.

(51) Int. Cl. F16M 5/00; B62D 27/02; B60K 5/12

(52) U.S. Cl. CPC F16M 5/00; B60K 5/1283; B62D 27/02

(57) ABSTRACT

An apparatus includes a chassis and a plurality of mounting members positioned on the chassis and structured to mount an engine. A contact member is in contact with a surface of each of the first set of the plurality of mounting members and is proximate to the chassis. The contact member includes a first material having a first hardness greater than a second hardness of a second material of the plurality of mounting members. The first set of mounting members are slidable over the contact member in response to thermal expansion of the engine.

### CROSS-REFERENCE TO RELATED APPLICATIONS

This application claims priority to and the benefit of U.S. Provisional Patent Application No. 62/190,605, entitled “Washers for Mounting Engine Mounting Members and Accommodating Thermal Growth,” filed Jul. 9, 2015, which is incorporated herein by reference in its entirety.

### TECHNICAL FIELD

The present disclosure relates generally to systems and methods for mounting engines on chassis.

### BACKGROUND

Engines are generally mounted and secured on a chassis via mounting members. The chassis may allow securing of the engine as well as vibration damping. Engines experience thermal expansion or growth over various operational cycles of the engine. Particularly large engines such as those used in power generation, automotive, marine, industrial, mining, pumping, locomotive, stationary mechanical power or other applications can experience significant thermal expansion or growth. Securing the engines immovably to the chassis can cause stresses to develop in the mounting members and/or the chassis causing cracks or failure of the mounting members, the chassis or fasteners used to couple the mounting members to the chassis. Conventional systems may employ various methods for accommodating thermal growth of engines such as to, trunnion mounts, elastomeric/spring isolators and closely coupling chassis with the engine to allow equal heating and expansion. These methods can be cumbersome and may require some modifications to the mounting structure.

### SUMMARY

In some embodiments, an apparatus includes a plurality of mounting members structured to mount an engine and a chassis, the plurality of mounting members positioned on the chassis. The apparatus further includes a contact member in contact with a surface of each of the mounting members, the surface proximate to the chassis. The contact member includes a first material and the mounting members include a second material, the first material having a first hardness greater than a second hardness of the second material, and the mounting members are slidable over the contact member in response to thermal expansion of the engine.

In some embodiments, an apparatus includes a plurality of mounting members structured to mount an engine. The apparatus further includes a chassis. A first surface of each of the mounting members is positioned on the chassis, the first surface of each of the mounting members is coated with a wear resistant coating having a first hardness greater than a second hardness of the chassis, and the wear resistant coating is in contact with the chassis and facilitates sliding of the mounting members over the chassis in response to thermal expansion of the engine.

In some embodiments, an apparatus includes a plurality of mounting members structured to mount an engine. The apparatus further includes a chassis. A first surface of each of the mounting members is positioned on the chassis, the chassis is coated with a wear resistant coating having a first hardness greater than a second hardness of the first surface of the mounting members, and the wear resistant coating is in contact with the first surface of the mounting members and facilitates sliding of the mounting members over the chassis in response to thermal expansion of the engine.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of an apparatus that includes an engine including a plurality of mounting members positioned on a chassis with a first set of mounting members positioned between a first washer and second washer.

FIG. 2 is a schematic illustration of another apparatus that includes an engine including a plurality of mounting members positioned on a chassis with each of the plurality of mounting members positioned between a first washer and second washer.

FIG. 3 is an image of a mounting member of an engine mounted on a chassis and positioned between a first washer and a second washer, the mounting member being slidable between the first washer and the second washer.

FIG. 4 is a schematic flow diagram of a method of mounting an engine including a first set of mounting and a second set of mounting members such that the first set of mounting members are slidably positioned between a first washer and a second washer.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to systems and methods for mounting engines on a chassis, and in particular to positioning at least a plurality of mounting members of an engine between two washers which have a hardness greater than the hardness of the mounting members as well as a favorable coefficient of friction, and are secured to the chassis. The mounting members are slidable between the washers to accommodate thermal expansion of the engine.

Embodiments of the systems and methods for mounting engines described herein may provide benefits including, for example: (1) mounting at least a portion of a plurality of mounting members of an engine on a chassis by positioning at least a portion of the mounting members between two surfaces (e.g., washers); (2) allowing the mounting members to slide between the surfaces or contact members (e.g., washers) which have a low coefficient of friction to accommodate thermal expansion of the engine; and (3) extending the lifetime of the washers by forming or coating the washers from a first material having a first hardness greater than the hardness of the mounting members and a reduced friction such that the washers experience reduced wear over multiple expansion cycles of the engine, thereby having a long life. Thermal expansion or growth of engines is a function of thermal loads and overall length of engine (the longer the engine, the larger delta the thermal growth and thereby the difference in length of the engine under hot and cold conditions. Thus, embodiments described herein are particularly used for high horse power engines which tend to be larger in size.

Engine systems such as those discussed herein may be utilized in conjunction with a power generation system, an automotive, marine, industrial, mining, pumping or any other stationary or mobile power applications. For example, an electric power generation system may include a generator coupled to the engine. The engine may be configured to drive the generator to generator electric power. The electric power may be used to drive a load. For example, a generator set including the engines discussed herein may be used to provide power to (e.g., supplement power on) a utility line or a residential or commercial power supply system. The generator set may provide power to various electrical systems, such as a hybrid vehicle powertrain, parallel to a power grid, provide isolated local power, an industrial motor or other industrial equipment, one or more batteries or other energy storage devices, and/or other types of electrical loads.

Various implementations of the present disclosure may utilize features disclosed in U.S. patent application Ser. No. 13/666,460, issued as U.S. Pat. No. 9,091,322, titled “Generator Set Mount,” filed Nov. 1, 2012, which is incorporated herein by reference in its entirety.

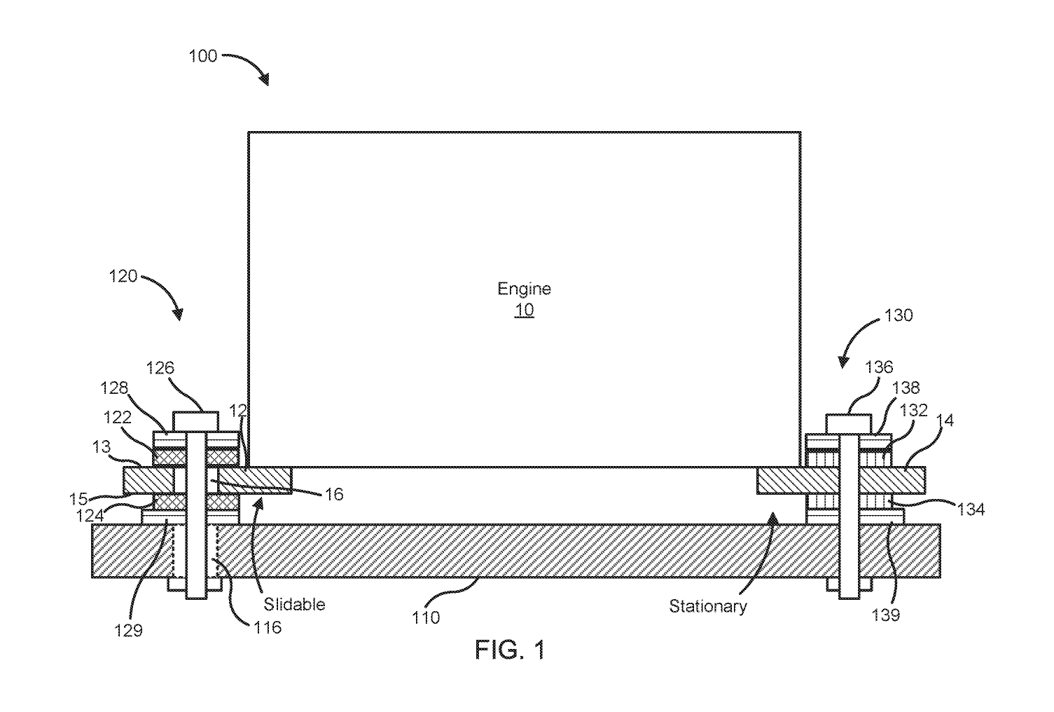

FIG. 1 is a schematic illustration of an embodiment of an apparatus 100 that includes an engine 10 mounted on a chassis 110 via a first mounting assembly 120 and a second mounting assembly 130. The engine 10 can include, for example, an internal combustion (IC) engine (e.g., a diesel engine, a gasoline engine, natural gas engine, a dual-fuel engine, etc.). In various embodiments, the engine 10 can include a high horse power engine (e.g., of a large physical size, length, or having a power output of greater than 500 kW). The engine 10 has a plurality of mounting members. A first set of the plurality of mounting members are slidably mounted on the chassis while a second set of mounting members are immovably mounted on the chassis as described below. In various embodiments, the each of the first set of mounting members can define an oversized clearance hole.

For example, FIG. 1 is a cross-section of a portion of the apparatus 100. The engine 10 includes a first mounting member 12 included in the first set of mounting members. The first mounting member 12 defines an oversized clearance hole 16 therethrough to allow for horizontal sliding movement of the first mounting member 12 and engine when thermal expansion occurs. In various embodiments, a clearance opening 116 can instead be provided in the chassis 110 to accommodate the horizontal sliding movement of the first mounting member 12. The first set of mounting members and thereby the first mounting member 12 can be positioned on a first end of the engine 10. The engine 10 also includes a second mounting member 14 included in a second set of mounting members of the plurality of mounting members. The second set of mounting members and thereby the second mounting member 14 can be positioned at a second end of the engine 10 opposite the first end.

In various embodiments, the engine 10 can include four mounting members with the first set of mounting members including two mounting members and the second set of mounting members including the remaining two mounting members. In other embodiments, the engine 10 can include six mounting members with three mounting members included in the first set of mounting members and three mounting members included in the second set of mounting members. In still other embodiment, the engine 10 includes six mounting members with four mounting members included in the first set of mounting members and two mounting members included in the second set of mounting members. Still other combinations of mounting members are included in other embodiments.

Each of the first set of mounting members are mounted on the chassis via a first mounting assembly 120. For example, as shown in FIG. 1, the first mounting member 12 is mounted on the chassis 110 via the first mounting assembly 120. The first mounting assembly 120 includes a first washer 122 in contact with a first surface 13 of the first mounting member 12. The first surface is distal to the chassis 110. As used herein, the term “distal” refers to positioned away from, facing away from or otherwise located distant from the chassis 110 relative to a second surface 15 of the first mounting member 12 as described herein.

A second washer 124 is in contact with the second surface 15 of the first mounting member 12 which is opposite the first surface 13. The second surface 15 is proximate to the chassis 110. As used herein the term “proximate” refers to positioned close to, facing towards or otherwise located nearer the chassis 110 relative to the first surface 13. For example, the second surface 15 faces towards the chassis 110 and the first surface 13 faces away from the chassis 110 and is distant from the chassis 110 relative to the second surface 15.

In the illustrated implementation, the first mounting member 12 and any other mounting member included in the first set of mounting members is secured between the first washer 122 and the second washer 124 via a clamp 126 or other retaining member. The clamp 126 can include, for example a fastener, e.g., a bolt inserted through the first washer 122, the oversized clearance hole 16, the second washer 124, and the chassis 110 to mounting the first mounting member 12 to the chassis 110. The clamp can be formed from any suitable strong and rigid material (e.g., ceramics, stainless steel or cast iron). The clamp 126 can include bolted joint which, in various embodiments, can include a spring. For example, a first compliance member 128 which can include, for example a shim or a spring (e.g., a Belleville spring) can be positioned between the clamp 126 and the first washer 122. In some embodiments, a second compliance member 129 which can include, for example a shim or a spring (e.g., a Belleville spring) can also be positioned between the second washer 124 and the chassis 110. The first compliance member 128 and/or the second compliance member 129 can serve to bias the first washer 122 and/or the second washer towards the first mounting member 12, and/or provide shock vibration damping or shock absorbing. In other words, the engine mounting member is positioned atop, and sometimes between, surfaces which allow the mounting member to slide upon and had properties which limit wear of the engine mounting member and mounting surfaces

At least a portion of the clamp 126 is positioned through the oversized clearance hole 16. The first mounting member 12 is slidable between the first washer 122 and the second washer 124 to accommodate thermal expansion of the engine 10. The oversized clearance hole 16 can have a width which is larger than a thickness of the portion of the clamp 126 positioned therethrough. This allows the first mounting member 12 to horizontally slide around the portion of the clamp 126 positioned within the oversized clearance hole 16 as the first mounting member 12 slides between the first washer 122 and the second washer 124 due to thermal expansion or growth of the engine 10.

In other embodiments, a clearance opening 116 is provided in the chassis 110. In such embodiments, the oversized clearance hole 16 in the first mounting member 12 can be excluded such that the entire first mounting assembly 120 (i.e., the clamp 126, the first washer 122 and the second washer 124) slide with the first mounting member 12 over the chassis 110. In such embodiments, the second washer 124 slides over the chassis 110 and provides wear resistance and a suitable coefficient of friction to facilitate horizontal sliding of the first mounting member 12 to accommodate thermal expansion of the engine 10.

While not shown, in some embodiments, the second washer 124 can be positioned below the chassis 110 such that the first washer 122 is now in contact with a top surface of the chassis 110, and the second washer 124 is in contact with a bottom surface of the chassis 110. The clamp 126 retains the chassis 110 between the first washer 122 and the second washer 124. Thermal expansion of the engine 10 causes the first washer 122 and the second washer 124 to slide over the chassis 110 to accommodate the thermal expansion. The clearance opening 116 allows the clamp 126 inserted therethrough the freely move therewithin to accommodate the thermal growth.

The first washer 122 and the second washer 124 include a first material having a first hardness which is greater than a second hardness of a second material forming the first mounting member 12, for example having a minimum difference between the first hardness and the second hardness of at least 5 HRC. For example, the first washer 122 and/or the second washer 124 can include ceramic, diamond and/or graphene. In particular embodiments, the first washer 122 and/or the second washer 124 include ceramic washers. The first mounting member 12 may include or be formed of, for example, cast iron.

In various embodiments, the first washer 122 and/or the second washer 124 are formed from a third material (e.g., cast iron or stainless steel). The first material (e.g., ceramic) is then coated on the third material forming the first washer 122 and/or the second washer 124. In other embodiments, the first washer 122 and/or the second washer 124 are monolithically formed from the first material (e.g., ceramic).

As described before, the first hardness of the first material included in the first washer 122 and/or the second washer 124 is greater than the second hardness of the second material (e.g., cast iron) included in the first mounting member 12, for example having a minimum difference between the first hardness and the second hardness of 5 HRC. In various embodiments, the first washer 122 and the second washer 124 can include a ceramic washer having a Knoop hardness in the range of 10 GPa to 20 GPa. Furthermore, the first mounting member 12 can be formed from cast iron having Knoop hardness in the range of 200 MPa to 300 MPa which is significantly lower than the Knoop hardness of the ceramic first washer 122 and second washer 124. Thus, the hardness and coefficient of friction of the first washer 122 and the second washer 124 allow thermal growth but also provide adequate friction to prevent the premature wear of the sliding surfaces due to dynamic loads to the first washer 122 and the second washer 124 caused by the operating engine 10.

The higher first hardness of the first washer 122 and/or the second washer 124 relative to the second hardness of the first mounting member 12 allows the first mounting member 12 to slide between the first washer 122 and the second washer 124 while causing reduced wear to the first washer 122 and the second washer 124. The high difference between the first hardness and the second hardness also prevents material transfer between the first surface 13 of the first mounting member 12 and the first washer 122, and the second surface 15 of the second mounting member 14 and the second washer 124. This extends the life of the first washer 122 and the second washer 124, thereby requiring infrequent or no replacement and reducing maintenance costs. Furthermore, the first material can have a low coefficient of friction (e.g. in the range of 0.2 to 0.8 which can allow sliding of the first mounting member 12 between the first washer 122 and the second washer 124 with minimal friction.

During operation, both the first washer 122 and the second washer 124, as well as the first mounting member 12 may wear although minimally. In various embodiments, in which the first washer 122 and the second washer 124 includes a coating (e.g., a ceramic coating thereon), the coating may wear over time. However the wear on the first mounting member 12 is negligible and is accommodated by the clamp assembly. In such embodiments, the coating is chosen to prevent material transfer (galling) from the first mounting member 12 to the first washer 122 and the second washer 124 which can eventually lead to failure of the first washer 122 and/or the second washer 124.

The second mounting member 14 is immovably coupled to the chassis 110 via a second mounting assembly 130. The second mounting member 14 can, for example, include one or more mounting apertures. The second mounting member 14 can be positioned between a first spacer 132 and a second spacer 134 (e.g., washers). A mounting fastener 136 can be inserted through the mounting aperture, the first spacer 132, the second spacer 134 and mating throughholes defined in the chassis 110 to immovably couple the second mounting member 14 to the chassis 110. A third compliance member 138 can be positioned between the mounting fastener 136 and the first spacer 132, and a fourth compliance member 139 can be positioned between the second spacer 134 and the chassis. The third compliance member 138 and the fourth compliance member 139 can be substantially similar to the first compliance member 128 and the second compliance member 129 described before herein.

Since the second mounting member 14 is immovably coupled to the chassis 110, the thermal expansion or growth of the engine urges the first mounting member 12 (and thereby the first set of mounting members) to slide between the first washer 122 and the second washer 124. In other words, the thermal expansion or growth of the engine 10 is directed towards the first set of mounting members.

It should be noted that the term “washer,” as used herein, is not limited to any particular size or shape. While some embodiments utilize a round, substantially flat washer, other shapes may be utilized in other embodiments. For example, in some embodiments, washers having a square or rectangular cross-section are utilized. In other embodiments, washers having a different type of regular or irregularly shaped cross-section are utilized. In various embodiments, the thicknesses of the washers may vary (e.g., based in part on the weight of the engine being mounted).

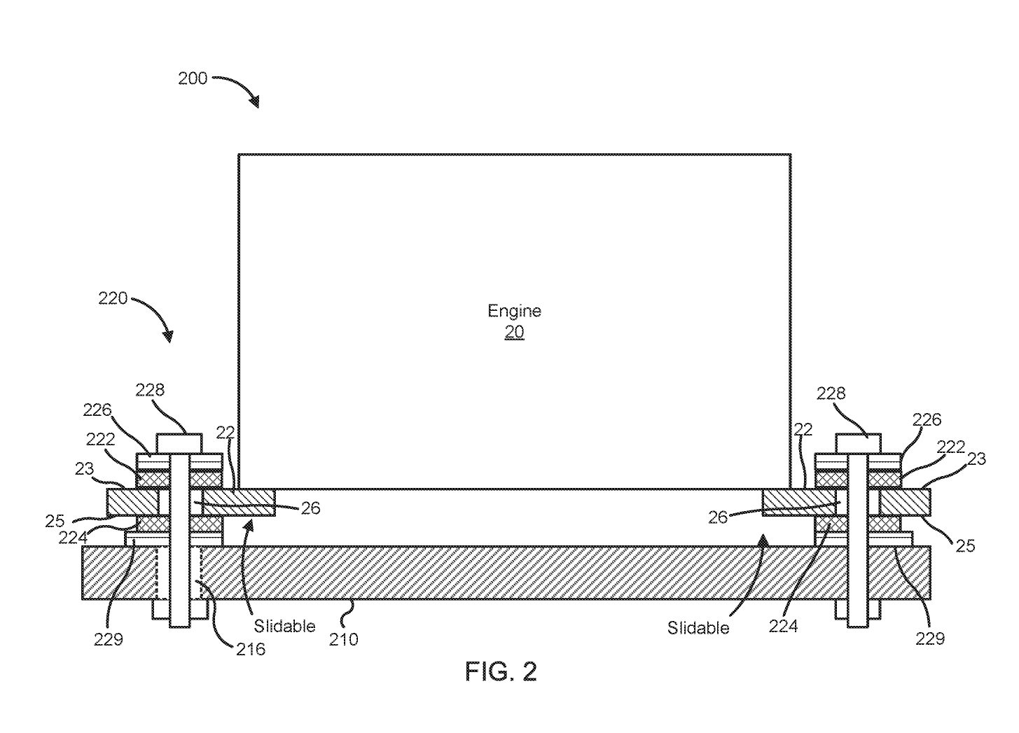

In some embodiments, each of a plurality of mounting members of an engine can be slidably positioned between a first washer and a second washer to mount the engine on a chassis. For example, FIG. 2 is a schematic illustration of another embodiment of an apparatus 200. The apparatus 200 includes an engine 20 mounted on a chassis 210.

The engine 20 includes a plurality of mounting members 22. Each of the plurality of mounting members 22 define an oversize clearance hole 26 therethrough. Each of the plurality of mounting members 22 can be substantially similar to the first mounting member 12 included in the engine 10 of the apparatus 100.

Each of the plurality of mounting members 22 are mounted on the chassis 210 via a mounting assembly 220. The mounting assembly 220 is substantially similar to the first mounting assembly 120 described before with respect to FIG. 1, which allows thermal expansion or growth of the engine in any direction. Briefly, the mounting assembly 220 includes a first washer 222 in contact with a first surface 23 of each of the plurality of mounting members 22. The first surface 23 is distal from the chassis 210. A second washer 224 is contact with a second surface 25 of each of the plurality of mounting members 22. The second surface 25 is proximate to the chassis 210. In this manner, each of the plurality of mounting members 22 or at least a portion thereof is positioned between the first washer 222 and the second washer 224.

The mounting assembly 220 also includes a clamp or retaining member 226. Each of the plurality of mounting members 22 are secured between the first washer 222 and the second washer 224 via the clamp 226 which can include, for example a fastener (e.g., a screw or a bolt). A first compliance member 228, for example a shim or a spring (e.g., a Belleville spring) can be positioned between the clamp 226 and the first washer 222. The clamp 226 is coupled to the chassis 210 to secure the mounting assembly 220 to the chassis 210.

At least a portion of the clamp 226 is positioned through the oversized clearance hole 26, and the second washer 224 to couple the mounting assembly 220 to the chassis 210. Each of the plurality of mounting member 22 are slidable between the first washer 222 and the second washer 224 to accommodate thermal expansion of the engine 20. The oversized clearance hole 26 has a width which is larger than a thickness of the portion of the clamp 226 positioned through the oversized clearance hole 26. This allows each of the plurality of mounting members 22 to slide around the portion of the clamp 226 positioned within the oversized clearance hole 26 as the mounting member 22 slides between the first washer 222 and the second washer 224 due to thermal expansion or growth of the engine 20.

As described before, the first washer 222 and the second washer 224 include a first material having a first hardness which is greater than a hardness of a second material of the mounting member 22 (e.g., having a minimum difference between the first hardness and the second hardness of 5 HRC), as described before with respect to the first mounting assembly 120. For example, the first washer 222 and/or the second washer 224 can include a ceramic, diamond or graphene. In particular embodiments, the first washer 222 and/or the second washer 224 include ceramic washers. In various embodiments, the first washer 222 and/or the second washer 224 is formed from a third material (e.g., cast iron or stainless steel). The first material (e.g., ceramic) is then coated on the third material to form the first washer 222 and/or the second washer 224. In other embodiments, the first washer 222 and/or the second washer 224 can be monolithically formed from the first material (e.g., ceramic). Moreover, the first washer 222 and the second washer 224 can have a low co-efficient of friction (e.g., in the range of 0.2-0.8) to allow easy sliding of the mounting member 22 therebetween.

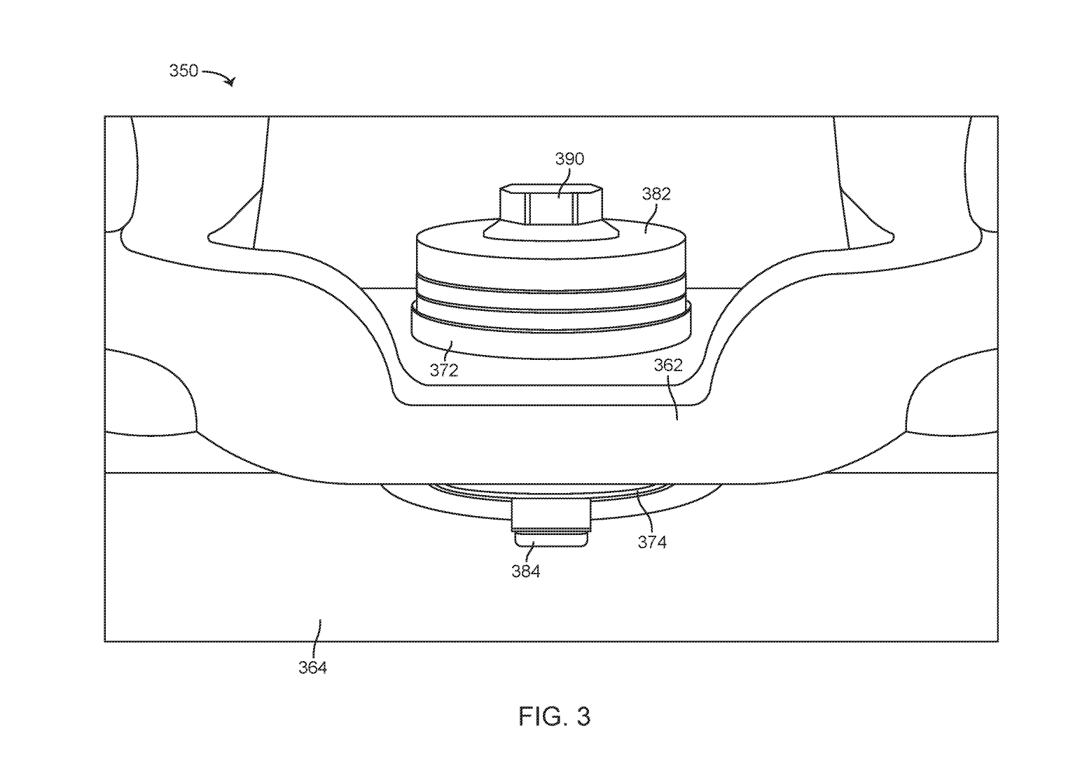

FIG. 3 is an image of a particular embodiment of a mounting assembly 350 for slidably mounting a mounting member 362 of an engine (not shown) to a chassis 364. The engine can include the engine 10, 20 or any other engine. In various embodiments, the mounting member 362 is formed from ductile cast iron or a suitable alternative.

A portion of the mounting member 362 is positioned between a first ceramic washer 372 and a second ceramic washer 374. The first ceramic washer 372 is in contact with a first surface of the mounting member 362 distal from the chassis 364, and the second ceramic washer 374 is in contact with a second surface of the mounting member 362 proximate to the chassis 364. Each of the first ceramic washer 372 and the second ceramic washer 374 are monolithically formed from the ceramic, for example aluminum oxide, zirconium oxide or any other suitable ceramic. A clamp 390, which includes a bolt, is used to secure the portion of the mounting member 362 between the first washer 372 and the second washer 374, and to the chassis 364. A first compliance member 382 is positioned between the clamp 390 and the first washer 372, and a second compliance member 384 is positioned between the second washer 374 and the chassis 364. At least a portion of the clamp 390 is positioned through a slot or otherwise oversized clearance hole defined in the mounting member 362. The clamp 390 is secured to the chassis 364 to mount the engine on the chassis 364.

The mounting member 362 is slidably positioned between the first ceramic washer 372 and the second ceramic washer 374, as described before herein. In some embodiments, the first ceramic washer 372 and second ceramic washer 374 have a significantly greater hardness than the mounting member 362 (e.g., cast iron mounting member). For example, the hardness of the first ceramic washer 372 and the second ceramic washer 374 can be at least 5 HRC greater than the hardness of the mounting member 362. Thus, the sliding of the mounting member 362 between the first ceramic washer 372 and the second ceramic washer 374 causes reduced wearing of the first ceramic washer 372 and the second ceramic washer 374. Thus the first ceramic washer 372 and the second ceramic washer 374 may have long life, for example last the entire lifetime of the engine, thereby reducing maintenance costs. Furthermore, the first ceramic washer 372 and the second ceramic washer 374 can have a low co-efficient of friction (e.g., in the range of 0.2-0.8), which can allow the mounting member 362 to slide easily between the first ceramic washer 372 and the second ceramic washer 374. While FIG. 3 is shown and described as including ceramic washers, washers formed from any other material (e.g., diamond, graphene, alloys, etc.) can be included in the apparatus illustrated in FIG. 3.

The mounting member 362 and/or other mounting members described herein may take any of a variety of shapes and/or sizes according to various embodiments. In some embodiments, the mounting member 362 may include a substantially flat, elongated portion against which the first ceramic washer 372 and the second ceramic washer 374 may be placed. In various embodiments, the mounting member 362 may have a rectangular, ovular, elliptical, or any other type of shape. In some embodiments, a width of the mounting member 362 may be greater than a width of the first ceramic washer 372 and/or the second ceramic washer 374 contacting the mounting member 362. In some embodiments, a thickness of the mounting member 362 may be greater than a thickness of the first ceramic washer 372 and/or the second ceramic washer 374. The mounting member 362, first ceramic washer 372, and second ceramic washer 374 may be designed to handle a large force from a large and heavy engine with reduced wear on the first ceramic washer 372 and the second ceramic washer 374. For example, in some implementations, the front-most mounting members may be subjected to reaction forces up to 170 kN by a 95 L compression ignition engine. In some embodiments, the surface area of the mounting member 362 may be enlarged to accommodate larger, heavier engines to lower surface pressure.

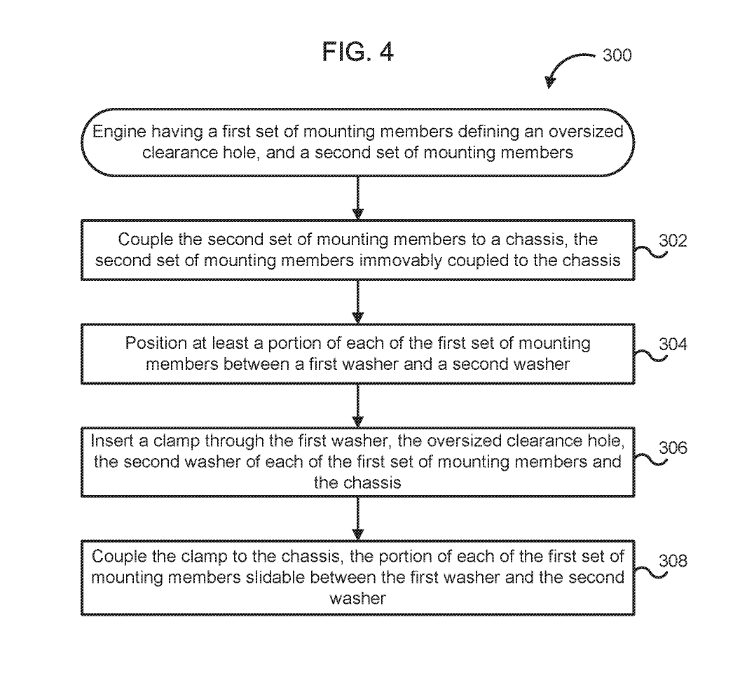

FIG. 4 is a schematic flow diagram of an example method 300 for mounting an engine (e.g., the engine 10) on a chassis (e.g., the chassis 110 or 210). The engine includes a first set of mounting members each of which define an oversized clearance hole (e.g., the oversized clearance hole 16 or 26) therethrough, and a second set of mounting members. The slot can include any opening through the mounting member, for example a circular opening, a rectangular opening (e.g., a slit) a square opening or an asymmetric opening.

The method 300 includes coupling the second set of mounting members to the chassis at 302. The second set of mounting members are immovably coupled to the chassis. For example, the second set of mounting members can include the second mounting member 14 which is positioned between the first spacer 132 and the second spacer 134. The second mounting member is immovably coupled to the chassis 110 via the mounting fastener 136 inserted through the second mounting member and mating throughhole defined in the chassis 110.

At least a portion of each of the first set of mounting members is positioned between the first washer and the second washer at 304. For example, each of the first set of mounting members can include the first mounting member 12. The first mounting member 12 is positioned between the first washer 122 and the second washer 124 which can include, for example, ceramic washers.

A clamp is inserted through the first washer, the oversized clearance hole and the second washer of the each of the first set of mounting members and the chassis at 306. For example, the clamp 126, which can include a fastener such as a bolt, is inserted through the first washer 122, the oversized clearance hole 16, the second washer 124 and the chassis 110.

The clamp is coupled to the chassis and the portion of the each of the first set of mounting members is slidable between the first washer and the second washer at 308. For example, the clamp 126 is coupled to the chassis 110. The first mounting member 12 is slidable between the first washer 122 and the second washer 124. As described before, the first washer 122 and the second washer 124 have a first hardness greater than a second hardness of the first mounting member 12, for example at least 5 HRC greater than the second hardness of the first mounting member 12. The higher hardness of the first washer 122 and the second washer 124 prevents any significant wear of the first washer 122 and the second washer 124 which can include, for example ceramic washers.

Furthermore, the first washer 122 and the second washer 124 may have a low coefficient of friction (e.g., in the range of 0.2-0.8). This allows the first mounting member 12 to slide easily between the first washer 122 and the second washer 124. In this manner, the thermal expansion of the engine 10 is accommodated while preventing wear of the first washer 122 and the second washer 124, thereby greatly reducing maintenance costs.

In various implementations, the mounting members of an engine 10 can be positioned using any suitable arrangement to accommodate thermal expansion or growth of the engine. For example, in one embodiment washers (e.g., the first washer 122) can be positioned on a chassis 110 at predetermined locations where a first of mounting members of the engine 10 are to be located. The first set of mounting members are positioned on corresponding washers coupled to the chassis. A second set of mounting members which can be located opposite the first set of mounting members can be immovable coupled to the chassis, for example using the second mounting assembly 130. The first set of mounting members are positioned on and in contact with the washers such that the first set of mounting members can slide freely on the washers to accommodate thermal expansion of the engine. In such implementations, the slot can be excluded from the first set of mounting members.

In other implementations, an opening (e.g., a slot, a slit, circular opening, a rectangular opening, etc.) can be provided in the washer (e.g., a ceramic washer) positioned between the mounting member and the chassis, as described above. Furthermore, a protrusion (e.g., a pin, a dowel, a screw, a bolt, a rivet etc.) can be provided on a base of the first set of mounting members which is configured to be inserted into the opening defined in the washer. The protrusion is inserted through the opening such that the opening provides a guide track for the protrusion as the protrusion displaces within the opening due to thermal expansion of the engine. In this manner, thermal growth of the engine is directed in a particular direction.

In still other implementations, the first material having the first hardness as described before, can be coated directly on the chassis, for example at particular locations on a surface of the chassis at which at least a first set of mounting members (e.g., the first mounting member 120) of the engine are to be positioned. The first mounting members are positioned in direct contact with the first material coated at the particular locations on the surface of the chassis. The first material coating can allow the mounting members of the engine to slide easily over the surface of the chassis at the particular location of the chassis to accommodate thermal expansion of the engine as described before. Furthermore, the first hardness of the first material is significantly greater than the second hardness of the second material of the mounting member, as described before, thereby preventing wear of the chassis. While not described here, other methods for accommodating thermal expansion of an engine mounted on a chassis are contemplated.

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

What is claimed is:

1. An apparatus, comprising:
a plurality of mounting members structured to mount an engine;
a chassis, the plurality of mounting members positioned on the chassis; and
a contact member in contact with a surface of each of the mounting members, the surface proximate to the chassis;
wherein the contact member comprises a first material and the mounting members comprise a second material, the first material having a first hardness greater than a second hardness of the second material, and the mounting members are slidable over the contact member in response to thermal expansion of the engine.

2. The apparatus of claim 1, wherein the contact member comprises a first washer, wherein the apparatus further comprises:
a second washer in contact with a first surface of each of the mounting members, the first surface distal from the chassis,
wherein at least one of the first washer and the second washer comprise the first material and the mounting members are slidable between the first washer and the second washer in response to thermal expansion of the engine.

3. The apparatus of claim 2, wherein the first material comprises a ceramic, diamond, or graphene.

4. The apparatus of claim 3, wherein the first material comprises a ceramic.

5. The apparatus of claim 3, wherein each of the first washer and the second washer comprises the first material.

6. The apparatus of claim 3, wherein the at least one of the first washer or the second washer comprises a third material different than the first material, wherein the third material is coated with the first material.

7. The apparatus of claim 3, wherein the at least one of the first washer or the second washer is formed from the first material.

8. The apparatus of claim 3, wherein the second material is cast iron.

9. The apparatus of claim 2, wherein each of the mounting members defines a clearance hole, the apparatus further comprising:
a clamp inserted through each of the first washer, the clearance hole, the second washer and the chassis to mount each of the mounting members to the chassis, the clearance hole having a diameter larger than a diameter of the clamp and allowing the mounting member to be slidable between the first washer and the second washer about the clamp.

10. The apparatus of claim 9, further comprising at least one of a first compliance member positioned between the clamp and the first washer and a second compliance member positioned between the second washer and the chassis.

11. The apparatus of claim 1, wherein a difference between the first hardness and the second hardness is at least 5 HRC.

12. An apparatus comprising:
a plurality of mounting members structured to mount an engine; and
a chassis,
a first surface of each of the mounting members is positioned on the chassis, the first surface of each of the mounting members coated with a wear resistant coating having a first hardness greater than a second hardness of the chassis, the wear resistant coating in contact with the chassis and facilitating sliding of the mounting members over the chassis in response to thermal expansion of the engine.

13. The apparatus of claim 12, wherein the first material comprises a ceramic, diamond, or graphene.

14. The apparatus of claim 13, wherein the first material comprises a ceramic.

15. The apparatus of claim 12, wherein each of the mounting members defines a clearance hole, the apparatus further comprising:
a clamp inserted through the clearance hole and the chassis to mount each of the mounting members to the chassis, the clearance hole having a diameter larger than a diameter of the clamp and allowing the mounting member to be slidable over the chassis about the clamp.

16. The apparatus of claim 12, wherein a difference between the first hardness and the second hardness is at least 5 HRC.

17. An apparatus comprising:
a plurality of mounting members structured to mount an engine; and
a chassis,
a first surface of each of the mounting members is positioned on the chassis, the chassis coated with a wear resistant coating having a first hardness greater than a second hardness of the first surface of the mounting members, the wear resistant coating in contact with the first surface of the mounting members and facilitating sliding of the mounting members over the chassis in response to thermal expansion of the engine.

18. The apparatus of claim 17, wherein the first material comprises a ceramic, diamond, or graphene.

19. The apparatus of claim 17, wherein each of the mounting members defines a clearance hole, the apparatus further comprising:
a clamp inserted through the clearance hole and the chassis to mount each of the mounting members to the chassis, the clearance hole having a diameter larger than a diameter of the clamp and allowing the mounting member to be slidable over the chassis about the clamp.

20. The apparatus of claim 17, wherein a difference between the first hardness and the second hardness is at least 5 HRC.
